(19) United States
(12) Patent Application Publication
(10) Pub. No.: US 2025/0208265 A1
(43) Pub. Date: Jun. 26, 2025

(54) PHASED ARRAY LIDAR CHIP AND LIDAR

(71) Applicant: Wuhan VanJee Optoelectronic Technology Co., Ltd., Wuhan (CN)

(72) Inventors: Yang XU, Wuhan (CN); Chuhuan FENG, Wuhan (CN); Yi LI, Wuhan (CN); Yongqiang DENG, Wuhan (CN)

(73) Assignee: Wuhan VanJee Optoelectronic Technology Co., Ltd., Wuhan (CN)

(21) Appl. No.: 19/001,425

(22) Filed: Dec. 25, 2024

(30) Foreign Application Priority Data
Dec. 25, 2023 (CN) 202311812160.1

(51) Int. Cl. G01S 7/481; G01S 17/02

(52) U.S. Cl. CPC G01S 7/4817; G01S 7/4815; G01S 7/4816; G01S 17/02

(57) ABSTRACT

The present disclosure is applicable to a field of lidar technology and provides a phased array lidar chip and a lidar. The phased array lidar chip includes an input coupler, an emitting module, and a receiving module. The input coupler is configured to couple a laser beam to the chip, and provide the laser beam to the emitting module; the emitting module includes at least one emitting unit, where the emitting unit is configured to emit the laser beam to a detection space; the receiving module includes multiple receiving units, where the receiving units are configured to receive an echo signal within the detection space, and each receiving unit corresponds to a different scanning range. The phased array lidar chip and the lidar provided by the present disclosure can achieve large field of view angle scanning.

### CROSS-REFERENCE TO RELATED APPLICATION

This application claims priority to Chinese Patent Application No. 202311812160.1, filed on Dec. 25, 2023. The entirety of the above-mentioned patent applications is hereby incorporated by reference herein and made a part of this specification.

### TECHNICAL FIELD

The present disclosure belongs to a field of lidar technology, and in particular relates to a phased array lidar chip and a lidar.

### BACKGROUND

Lidar has been widely used in areas such as autonomous driving, 3D printing, virtual reality, augmented reality, and smart transportation. With the promotion of application scope, new requirements have been put forward for the performance parameters of lidar. In current mechanical lidars and hybrid solid-state lidars, rotating components and mechanical components have defects such as short service lifetime, high cost, and large volume. Responding to the above issues, pure solid-state phased array lidar based on integrated optical chips have emerged. Pure solid-state phased array lidar can combine advanced optical and electronic technologies to provide more advanced, more compact, and more reliable lidar solutions, especially suitable for autonomous driving, robotics technology, and other fields that require high-performance laser sensing.

At present, the pure solid-state phased array lidar generally use electro-optic shifters or thermal-optical phase shifters to achieve scanning in a first dimension, and change the wavelength to achieve scanning in a second dimension. Due to the limited tuning range of tunable light sources, the scanning range in the second dimension is only about 20°, which cannot meet the requirements of autonomous driving for field of view angle.

### SUMMARY

The purpose of the present disclosure is to provide a phased array lidar chip and a lidar, aiming to improve the technical problem that the scanning range of the phased array lidar chip in the prior art is small and cannot meet the requirements of autonomous driving for field of view angle.

The present disclosure is implemented in the following manner. In a first aspect, a phased array lidar chip is provided, which includes:
an input coupler, configured to couple a laser beam to the phased array lidar chip, and provide the laser beam to an transmission module;
the emitting module, including at least one emitting unit, where the emitting unit is configured to emit the laser beam to a detection space;
a receiving module, including multiple receiving units, where the receiving units are configured to receive an echo signal within the detection space, and each receiving unit corresponds to a different scanning range.

In some embodiments, the phased array lidar chip further includes:
a first beam splitter, configured to receive the laser beam provided by the input coupler, dividing the laser beam into a detection light and a reference light, and providing the detection light to the emitting module, emitting the detection light to the detection space by the emitting module; and
a first beam combiner, configured to receive the reference light and the echo signal, where the reference light and the echo signal are combined in the first beam combiner to generate a beat-frequency signal.

In some embodiments, the phased array lidar chip further includes a detection module, the detection module is configured to receive the beat-frequency signal and convert the beat-frequency signal into a difference-frequency electrical signal.

In some embodiments, the receiving units and the emitting units are provided in one-to-one correspondence, and a receiving unit and an emitting unit that are provided in correspondence have a same scanning range and form a transceiver unit.

In some embodiments, the phased array lidar chip further includes a second beam splitter, the second beam splitter is located between the first beam splitter and the emitting module, the second beam splitter is configured to divide the detection light into multiple beams and respectively provide the multiple beams to the multiple emitting units.

In some embodiments, the phased array lidar chip further includes multiple first optical switches, the first optical switches are located between the input coupler and the first beam splitters, the multiple first optical switches and multiple emitting units are provided correspondingly, and the first optical switches are configured to control conduction of corresponding transceiver units.

In some embodiments, the phased array lidar chip further includes multiple second optical switches and multiple third optical switches; the second optical switches are located between the input coupler and the emitting units, the multiple second optical switches and the multiple emitting units are provided correspondingly, the second optical switches are configured to control conduction of corresponding emitting units; the multiple third optical switches and the multiple receiving units are provided correspondingly, the third optical switches are located between the receiving beam combiner and the detection module, the third optical switches are configured to control conduction of corresponding receiving units.

In some embodiments, the emitting unit includes an emitting beam splitter, a first phase shifter group and a first grating antenna that are sequentially connected; the laser beam is capable of sequentially passing through the emitting beam splitter, the first phase shifter group and the first grating antenna to emit to the detection space;
the receiving unit includes a receiving beam combiner, a second phase shifter group and a second grating antenna that are sequentially connected, the echo signal is capable of sequentially passing through the second grating antenna, the second phase shifter group and the receiving beam combiner to be received.

In some embodiments, in at least one transceiver unit, the emitting unit includes two emitting beam splitters and two first phase shifter groups, two emitting beam splitters and two first phase shifter groups in a same emitting unit are respectively provided at two sides of a same first grating antenna, two emitting beam splitters in a same emitting unit are connected to the input coupler through a first selective switch;
the receiving unit includes two receiving beam combiners and two second phase shifter groups, two receiving beam combiners and two second phase shifter groups in a same receiving unit are respectively provided at two sides of a same second grating antenna, two receiving beam combiners in a same receiving unit are connected to a same detection module through a second selective switch.

In some embodiments, the emitting unit is provided with one, the first grating antenna is provided with multiple areas, and each area corresponds to a different scanning range.

In some embodiments, both the first grating antenna and the second grating antenna are any one of a sidewall-etched grating, a shallow-etched grating, a full-etched grating and a loading-type grating.

In a second aspect, a lidar is provided, which includes a laser and the phased array lidar chip according to a respective embodiment described above, the laser is configured to provide a laser beam.

The technical effect of the first aspect of the present disclosure compared to the prior art is that: the phased array lidar chip provided by an embodiment of the present disclosure includes an input coupler, an emitting module, and a receiving module; where the receiving module includes multiple receiving units, and each receiving unit corresponds to a different scanning range. In this way, compared to respective receiving units all corresponding to a same scanning range, the scanning range of the phased array lidar chip can be increased to a certain extent, so that it can meet the requirements of autonomous driving for field of view angle.

It can be understood that the beneficial effects of the second aspect described above can be found in the relevant description of the first aspect, which will not be further elaborated here.

### BRIEF DESCRIPTION OF DRAWINGS

In order to illustrate the technical solutions of embodiments of the present disclosure more clearly, the drawings that need to be used in the description of the embodiments of the present disclosure or the prior art will be briefly introduced in the following. Obviously, the drawings in the following description are some embodiments of the present disclosure. For those of ordinary skill in the art, other drawings can be obtained according to these drawings without paying any creative effort.

FIG. 1 is a schematic structure diagram of a lidar including a phased array lidar chip provided by an embodiment of the present disclosure.

FIG. 2 is a schematic structure diagram of a lidar including a phased array lidar chip provided by another embodiment of the present disclosure.

FIG. 3 is a schematic structure diagram of a lidar including a phased array lidar chip provided by another embodiment of the present disclosure.

FIG. 4 is a schematic structure diagram of a lidar including a phased array lidar chip provided by another embodiment of the present disclosure.

FIG. 5 is a schematic diagram of the variation of phase gradient of a detection light after passing through an emitting unit in a phased array lidar chip provided by an embodiment of the present disclosure.

FIG. 6 is a schematic diagram of phase distribution of a detection light after passing through an emitting unit in a phased array lidar chip provided by an embodiment of the present disclosure.

FIG. 7 is a schematic diagram of an output point cloud after a detection light passing through an emitting unit in a phased array lidar chip provided by an embodiment of the present disclosure.

FIG. 8 is a schematic structure diagram of a first grating antenna in a phased array lidar chip provided by an embodiment of the present disclosure.

FIG. 9 is a schematic structure diagram of a lidar including a phased array lidar chip provided by another embodiment of the present disclosure.

FIG. 10 is a schematic diagram of longitudinal field of view corresponding to the phased array lidar chip as shown in FIG. 9.

FIG. 11 is a schematic structure diagram of a lidar including a phased array lidar chip provided by another embodiment of the present disclosure.

FIGS. 12A, 12B, and 12C are schematic structure diagrams of a first grating antenna in a phased array lidar chip.

### BRIEF DESCRIPTION OF REFERENCE SIGNS

10: substrate; 11: optical isolation layer; 12: waveguide layer; 13: first area; 14: second area; 100: laser; 200: transceiver unit; 210: emitting unit; 211: emitting beam splitter; 212: first phase shifter group; 213: first grating antenna; 214: first selective switch; 220: receiving unit; 221: detection module; 222: receiving beam combiner; 223: second phase shifter group; 224: second grating antenna; 226: second selective switch; 300: second beam splitter; 400: first optical switch; 500: second optical switch; 600: third optical switch; 700: first beam splitter; 800: first beam combiner.

### DESCRIPTION OF EMBODIMENTS

Embodiments of the present disclosure are described in detail in the below, examples of the embodiments are shown in the accompanying drawings, where identical or similar reference signs throughout represent identical or similar components or components with identical or similar functions. The embodiments described in the below with reference to the accompanying drawings are exemplary and intended to explain the present disclosure, but cannot be understood as limitations to the present disclosure.

In the description of the present disclosure, it should be understood that orientations or position relationships indicated by terms “length”, “width”, “up”, “down”, “front”, “back”, “left”, “right”, “vertical”, “horizontal”, “top”, “bottom”, “inside”, “outside”, etc. are orientations or position relationships based on the orientation or position relationship shown in the drawings, which is only for the convenience of describing the present disclosure and simplifying the description, and does not indicate or imply that an apparatus or an element referred to must have a specific orientation or be constructed and operated in a specific orientation, and therefore, cannot be understood as a limitation of the present disclosure.

In addition, terms “first” and “second” aims only to be used for description and cannot be understood as indicating or implying relative importance or indicating a quantity of technical features implicitly. Therefore, features limited with “first” and “second” can explicitly or implicitly include one or more of these features. In the description of the present disclosure, “multiple” means two or more than two, unless otherwise limited specifically.

In the present disclosure, unless otherwise specified and limited, terms “installation”, “link”, “connection”, “fixation” and other terms should be broadly understood, for example, they can be fixed connections, detachable connections, or integrated; they can be mechanical connections or electrical connections; they can be directly connection or indirectly connection through an intermediate medium, they can be an internal connection of two components or an interaction relationship between two components. For those of ordinary skill in the art, specific meanings of the terms described above in the present disclosure can be understood based on specific circumstances.

In order to make the purpose, technical solution, and advantages of the present disclosure clearer and understandable, the present disclosure will be further explained in detail in conjunction with the accompanying drawings and embodiments in the below.

A lidar generally includes a laser and a phased array lidar chip; where the laser is configured to provide a laser beam, the phased array lidar chip is configured to receive and emit the laser beam into a detection space. However, the scanning range of the phased array lidar chip at present is small and cannot meet the requirements of autonomous driving for field of view (or field of view angle).

In order to improve the issues mentioned above, an embodiment of the present disclosure provides a phased array lidar chip. The phased array lidar chip includes an input coupler, an emitting module, and a receiving module; where the receiving module includes multiple receiving units, and each receiving unit corresponds to a different scanning range. In this way, compared to all respective receiving units corresponding to a same scanning range, the scanning range of the phased array lidar chip can be enlarged to a certain extent, so that it can meet the requirements of autonomous driving for field of view angle.

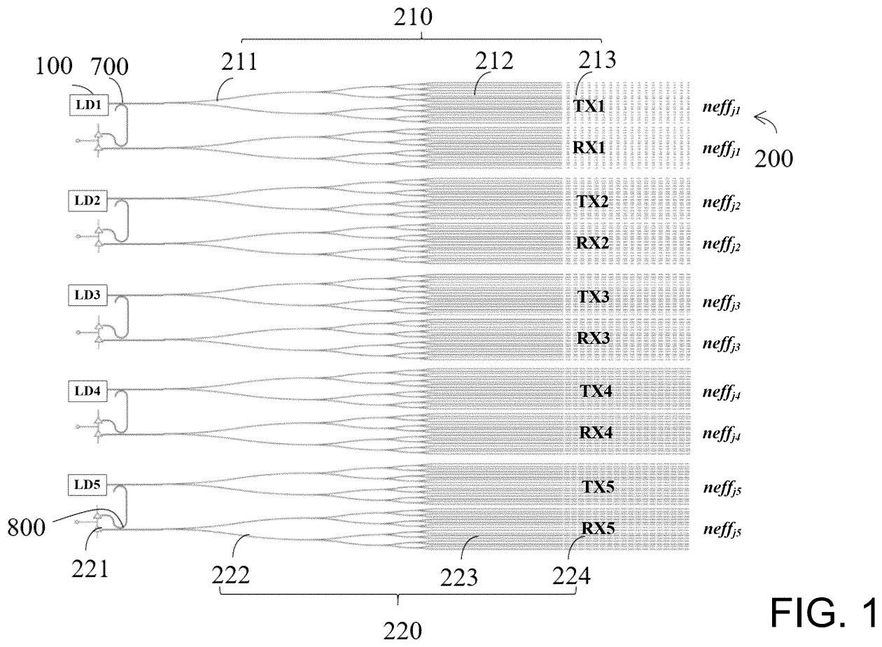

Please refer to the lidar shown in FIG. 1, the phased array lidar chip includes an input coupler, an emitting module, and a receiving module.

The input coupler is configured to couple a laser beam to the chip, and provide the laser beam to the emitting module. The emitting module includes at least one emitting unit 210, and the emitting unit 210 is configured to emit the laser beam to a detection space. The receiving module includes multiple receiving units 220, and the receiving units 220 are configured to receive an echo signal within the detection space, and each receiving unit 220 corresponds to a different scanning range.

The emitting unit 210 in this embodiment may be provided with one or more, which can be determined specifically according to usage requirements.

Refer to FIG. 1 again, the working process of the lidar including the phased array lidar chip is as follows.

A laser 100 provides a laser beam, the laser beam used as an input light beam is coupled to the chip through the input coupler, part of the laser beam used as detection light enters into the emitting module, and emits into a detection space by the emitting unit 210 of the emitting module.

After that, the detection light entering into the detection space is reflected by obstacles to form an echo signal. The echo signal is received by the receiving unit 220 and processed by combining with the reference beam in the first beam combiner 800. The processed signal is then transmitted to a detection module 221 of the chip or outside the chip, where the processed signal is converted from optical signal into a electrical signal, and then the electrical signal is processed via an external data processing apparatus to obtain relevant measurement data of the obstacles in a detection area, such as distance, speed and obstacle volume, etc.

The phased array lidar chip provided by the embodiment of the present disclosure includes an input coupler, an emitting module, and a receiving module; where the receiving module includes multiple receiving units 220, and each receiving unit 220 corresponds to a different scanning range. In this way, compared to all respective receiving units 220 corresponding to a same scanning range, the scanning range of the phased array lidar chip can be enlarged to a certain extent, so that it can meet the requirements of autonomous driving for field of view angle.

As shown in FIG. 1, in some embodiments, the phased array lidar chip further includes a first beam splitter 700 and a first beam combiner 800. The first beam splitter 700 receives the laser beam provided by the input coupler, and divides the laser beam into a detection light and a reference light, and provides the detection light to the emitting module, and provides the reference light to the first combiner 800; where the emitting module emits the detection light to the detection space. The first beam combiner 800 receives the reference light and the echo signal. The reference light and the echo signal are combined in the first beam combiner 800 to generate a beat-frequency signal.

The first beam splitter 700 may have two light outputs, three light outputs, or more light outputs, which can be determined according to usage requirements. The first beam combiner 800 may have two light inputs, three light inputs, or more light inputs, which can be determined according to usage requirements.

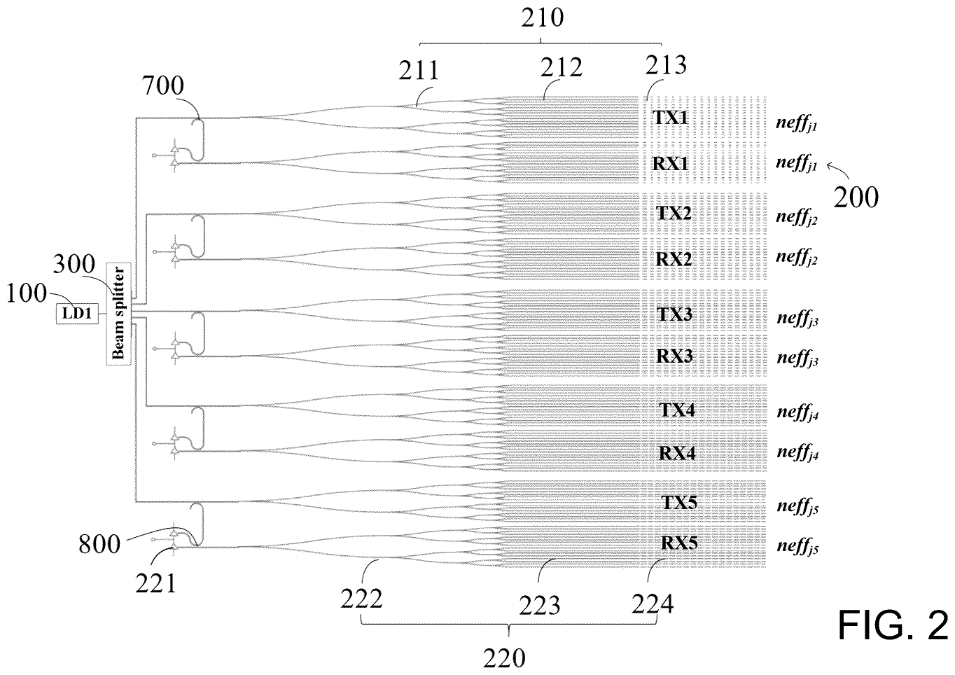

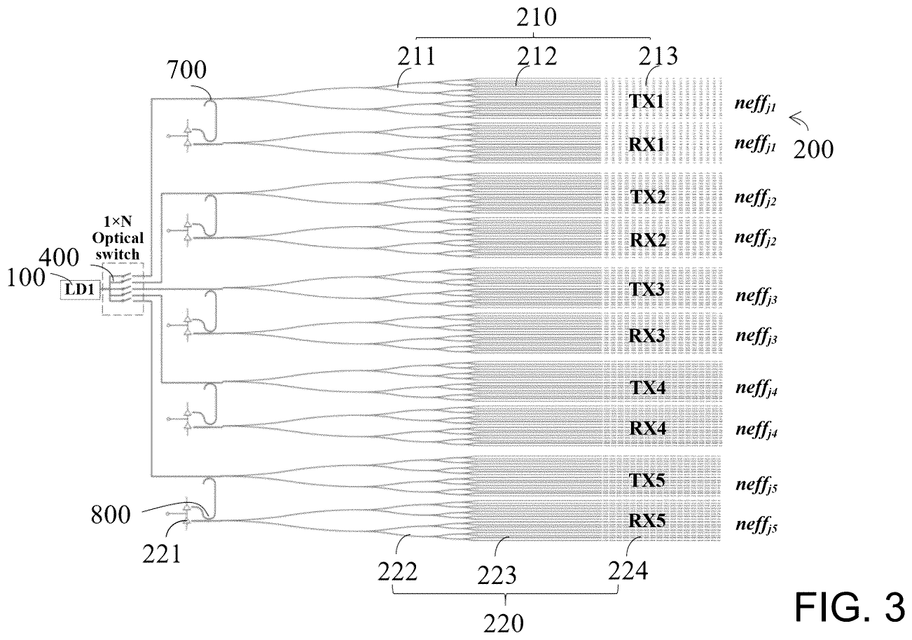

As shown in FIG. 1, FIG. 2, and FIG. 3, in some embodiments, both the emitting unit 210 and the receiving unit 220 are provided with multiple. The emitting unit and the receiving unit are provided one-to-one, the corresponding emitting unit and the receiving unit have the same scanning range, and constitute a transceiver unit. In this case, one first beam splitter 700 and one first beam combiner 800 are both arranged to each transceiver unit, for example, the first beam splitter can be arranged between each emitting unit 210 and the laser 100. Each first beam splitter 700 may have two light outputs, and the laser beam is couple to the two outputs to be detection light and reference light separately; where one light output is configured to output a detection light to the emitting unit 210, the other light output is configured to output the reference light to the first combiner 800. As shown in FIG. 4, in some other embodiments, the first beam splitter 700 can be provided with one, the detection light can be divided into multiple beams again by a beam splitting structure and be provided to the multiple emitting units 210; the first beam combiner 800 can also be provided with one, the echo signal conducted by the multiple receiving units 220 can be combined by the first beam combiner.

The solution adopted in this embodiment can result in higher integration and more compact structure of the phased array lidar chip.

As shown in FIG. 1, in some embodiments, the phased array lidar chip further includes a detection module 221. The detection module 221 is configured to receive the beat-frequency signal and convert the beat-frequency signal into a difference-frequency electrical signal.

The detection module 221 may include one or more detectors, and may also include other structures according to usage requirements, which can be determined specifically according to usage requirements.

The solution provided in this embodiment can result in higher integration and more comprehensive functionality of the phased array lidar chip.

As shown in FIG. 1, in some embodiments, the receiving units 220 and the emitting units 210 are provided in one-to-one correspondence, and a receiving unit 220 and an emitting unit 210 that are provided in correspondence have a same scanning range and form a transceiver unit 200.

The quantity of the emitting units 210 and the quantity of the receiving units 220 are consistent and provided in one-to-one correspondence. A receiving unit 220 and an emitting unit 210 provided in correspondence refer to the receiving unit 220 and the emitting unit 210 that have a same scanning range.

The phased array lidar chip in this embodiment has multiple groups of transceiver units 200 (referred as TX/RX), including but not limited to 2-20 groups of transceiver units 200. TX is an abbreviation of Transmit, representing an emitting unit 210; RX is an abbreviation of Receive, representing a receiving unit 220. A scanning range of a different transceiver unit 200 is different. Under an input beam with the same wavelength, emission angles in a wavelength direction (referred as a second dimension) are not the same for different transceiver units, and an angle range of the second dimension is divided into multiple sub-areas. Then using a tunable light source (i.e. a laser 100) to change the wavelength of the incident light (laser beam) can cover respective emission angles within respective sub-areas. Based on the above solution, a field of view may be obtained by a single chip, where the scanning range is about 120° in the a phase direction (referred as a first dimension) and the scanning range is about 80°-100° in the second dimension.

A single TX/RX unit can achieve a scanning range of 120° in the phase direction, and the emission angle in the wavelength direction generally varies with wavelength from 0.05°/nm to 0.16°/nm. A single TX/RX unit can generally achieve a scanning range of around 16° in the wavelength range of nearly around 100 nm. By splicing between different scanning ranges of arrays, a wavelength scanning range of 80° is finally achieved.

As shown in FIG. 2, in some embodiments, the phased array lidar chip further includes a second beam splitter 300. The second beam splitter 300 is located between the input coupler and the emitting module (in an implementation, the second beam splitter 300 is located between the first beam splitters 700 and the emitting module), the second beam splitter 300 is configured to divide the detection light into multiple sub-beams and respectively provide the multiple sub-beams to the multiple emitting units.

By adopting the solution provided in this embodiment, multiple emitting units 210 can share one laser 100, reducing the number of lasers 100 and the number of external circuit control units, reducing system complexity, and resulting in lower product cost and compact structure of the lidar applying the phased array lidar chip provided by this embodiment. In this embodiment, the laser provides laser beams to all transceiver units, and the transceiver units may scan simultaneously.

As shown in FIG. 3, in some embodiments, the phased array lidar chip further includes multiple first optical switches 400, the first optical switches 400 are located between the input coupler and the emitting units 210 (in an implementation, the first optical switches 400 are located between the input coupler and the first beam splitters 700), and used to switch among the transceiver units. The multiple first optical switches 400 and multiple emitting units 210 are provided correspondingly, and the first optical switches 400 are configured to control conduction of corresponding emitting units 210 or corresponding receiving units 220; in an implementation, the first optical switches 400 are configured to control conduction of corresponding transceiver units 200, i.e. corresponding emitting units 210 and receiving units 220; that is, the first optical switch receives the laser beam from input coupler, and transmit it to a corresponding first splitter in which the laser beam is split into detection light and reference light, where the detection light enters into the corresponding emitting unit.

According to the solution provided in this embodiment, the input can be switched between different transceiver units 200 by adopting a single tunable laser 100 and utilizing the first optical switch 400. Each transceiver unit 200 respectively corresponds to a longitudinal emission angle range, and the longitudinal emission angle ranges of multiple transceiver units 200 are spliced to achieve large angle emission. The implementation methods of the first optical switch 400 include but are not limited to electro-optical switch, thermal-optical switch, wavelength selective switch, etc.

By adopting the solution provided in this embodiment, it is possible to make the multiple transceiver units 200 capable of achieving single-channel conduction according to the needs of use, which in turn enables the user to select a suitable detection range according to detection needs, achieving precise control and reducing power consumption.

As shown in FIG. 4, in some embodiments, the phased array lidar chip further includes multiple second optical switches 500, and multiple third optical switches 600. The second optical switches 500 are located between the input coupler and the emitting units 210. The multiple second optical switches 500 and the multiple emitting units 210 are provided correspondingly. The second optical switches 500 are configured to control conduction of corresponding emitting units 210. The multiple third optical switches 600 and the multiple receiving units 220 are provided correspondingly. The third optical switches 600 are located between the receiving beam combiner 222 and the detection module 221. The third optical switches 600 are configured to control conduction of corresponding receiving units 220.

Refer to FIG. 3, in some embodiments, the phased array lidar chip further includes a first OTDM (Optical Time Division Multiplexing) unit (not shown in FIG. 3), which includes multiple first optical switches 400, the first optical switches 400 are located between the input coupler and the emitting units 210 (in an implementation, the first optical switches 400 are located between the input coupler and the first beam splitters 700), and used to switch among the transceiver units. The multiple first optical switches 400 and multiple emitting units 210 are provided correspondingly, and the first optical switches 400 are configured to control conduction of corresponding emitting units 210 or corresponding receiving units 220; in an implementation, the first optical switches 400 are configured to control conduction of corresponding transceiver units 200, i.e. corresponding emitting units 210 and receiving units 220; that is, the first optical switch receives the laser beam from input coupler, and transmits it to a corresponding first splitter in which the laser beam is split into detection light and reference light, where the detection light enters into the corresponding emitting unit.

According to the solution provided in this embodiment, a single tunable laser is used to provide laser beam, and the laser beam is transmitted to transceiver units by multiple first optical switches of the first OTDM unit. Each transceiver unit 200 respectively corresponds to a longitudinal emission angle range, and the longitudinal emission angle ranges of multiple transceiver units 200 are spliced to achieve large angle emission. The implementation methods of the first optical switch 400 include but are not limited to electro-optical switch, thermal-optical switch, wavelength selective switch, etc.

By adopting the solution provided in this embodiment, it is possible to make the multiple transceiver units 200 capable of achieving single-channel conduction according to the needs of use, which in turn enables the user to select a suitable detection range according to detection needs, achieving precise control and reducing power consumption.

Refer to FIG. 4, in some embodiments, the phased array lidar chip further includes a second OTDM unit and a third OTDM unit (not shown in FIG. 4); where the second OTDM unit includes multiple second optical switches 500, and the third OTDM unit includes multiple third optical switches 600. The second optical switches 500 are located between the input coupler and the emitting units 210. The multiple second optical switches 500 and the multiple emitting units 210 are provided correspondingly. The second optical switches 500 are configured to control conduction of corresponding emitting units 210. The multiple third optical switches 600 and the multiple receiving units 220 are provided correspondingly. The third optical switches 600 are located between the receiving beam combiner 222 and the detection module 221. The third optical switches 600 are configured to control conduction of corresponding receiving units 220. In this embodiment, the laser beam is divided into detection light and reference light by the first beam splitter; where the detection light enters into the second OTDM unit and is transmitted to an emitting unit by corresponding second optical switch, and is emitted into detection space. Then the echo signal corresponding to the detection light is received by the detection unit, and transmitted to the first combiner through the third optical switch. The reference light enters into the first combiner, and is mixed with echo signal to generate beat-frequency signal.

In order to reduce the number of balanced detectors and the number of backend circuits received, and to reduce system complexity, the structure shown in FIG. 4 can be adopted. The respective receiving antenna (i.e. the second grating antenna 224) can be connected and gated using a 1×N third optical switch array including the multiple third optical switches 600, which is time-synchronized and port-corresponding with the 1×N second optical switch array including the multiple second optical switches 500. Based on the above methods, the complexity of the optical system can be reduced to a single tunable laser 100 and a pair of balanced detectors.

As shown in FIG. 1, in some embodiments, the emitting unit 210 includes an emitting beam splitter 211, a first phase shifter group 212 and a first grating antenna 213 that are sequentially connected. The laser beam is capable of sequentially passing through the emitting beam splitter 211, the first phase shifter group 212 and the first grating antenna 213 to emit to the detection space.

The emitting beam splitter 211 is configured to receive a detection light, and divide the detection light into multiple sub-beams. The emitting beam splitter 211 has multiple signal output terminals, the first phase shifter group 212 has multiple first phase shifters, the multiple first phase shifters are connected to the multiple signal output terminals correspondingly. Each first phase shifter is configured to receive and conductively output one sub-beam therein correspondingly, and also configured to shift phase of the sub-beam so as to change the emission angle range of this sub-beam in a transversal direction. The first grating antenna 213 is configured to receive, conduct, and output all sub-beams conducted by the first phase shifter group 212, and combine all the split beams, and further configured to change the emission angle range in the longitudinal direction of the detection light after being combined.

The receiving unit 220 includes a receiving beam combiner 222, a second phase shifter group 223 and a second grating antenna 224 that are sequentially connected. The echo signal is capable of sequentially passing through the second grating antenna 224, the second phase shifter group 223 and the receiving beam combiner 222 to be received.

The second grating antenna 224 is configured to receive and transmit the echo signal formed by the detection light after being reflected via the detection space, and echo signals received by different second grating antennas correspond to different receiving angle ranges, because each second grating antennas has a receiving different angle range in the longitudinal direction to others. The second phase shifter group 223 has multiple second phase shifters. The receiving beam combiner 222 have multiple signal input terminals, each signal input terminal is connected to one second phase shifter. The receiving beam combiner 222 is configured to receive and combine the echo signal conducted by the second phase shifter group 223, and also configured to transmit the echo signal after being combined to the detection module 221. The detection module 221 is configured to receive and process the echo signal.

In this embodiment, all emitting units 210 are capable of emitting the detection light from multiple emission angle ranges outward, and the effective refractive index of the first grating antenna 213 in a different emitting unit 210 is different. Correspondingly, the effective refractive index of the second grating antenna 224 in a different receiving unit 220 is different.

All emitting units 210 described above are capable of emitting the detection light from multiple emission angle ranges outward, when the emitting unit 210 is provided with one, it can be achieved by arranging multiple areas with different effective refractive indexes in the first grating antenna 213; when the emitting unit 210 is provided with multiple, it can be achieved by making an effective refractive index of a first grating antennas 213 in a different emitting unit 210 different, which can be determined specifically according to usage requirements.

Different effective refractive indexes can be achieved by changing a width, depth, etc. between adjacent grating strips in the first grating antenna 213 and the second grating antenna 224, which can be determined specifically according to usage requirements.

In the multiple emission angle ranges described above, any two emission angle ranges can have an overlapping area, or can have no overlapping area. For example, one emission angle range can be 0°-10°, while the other emission angle range can be 10°-20° or 5°-20°, which can be determined specifically according to usage requirements.

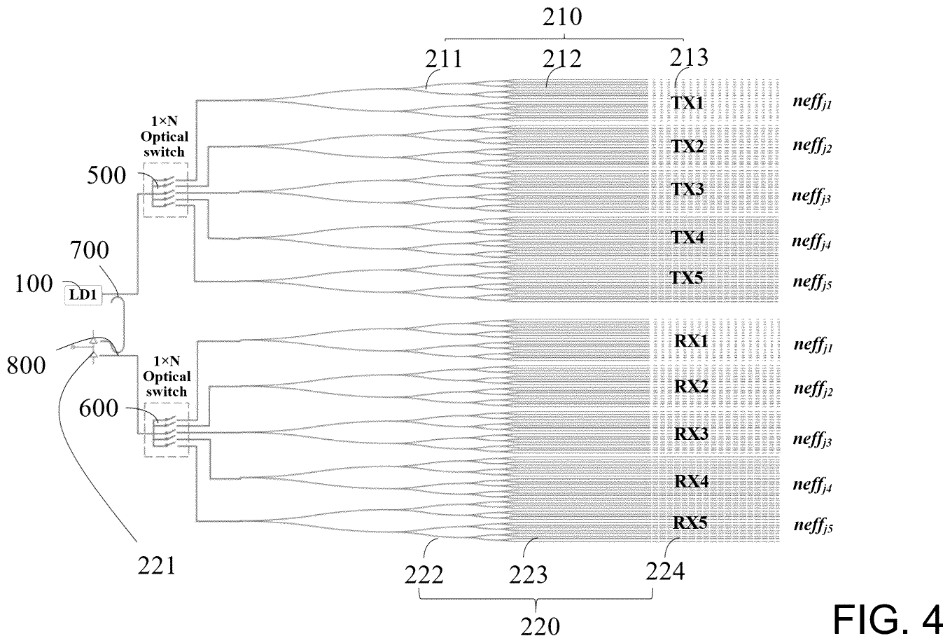

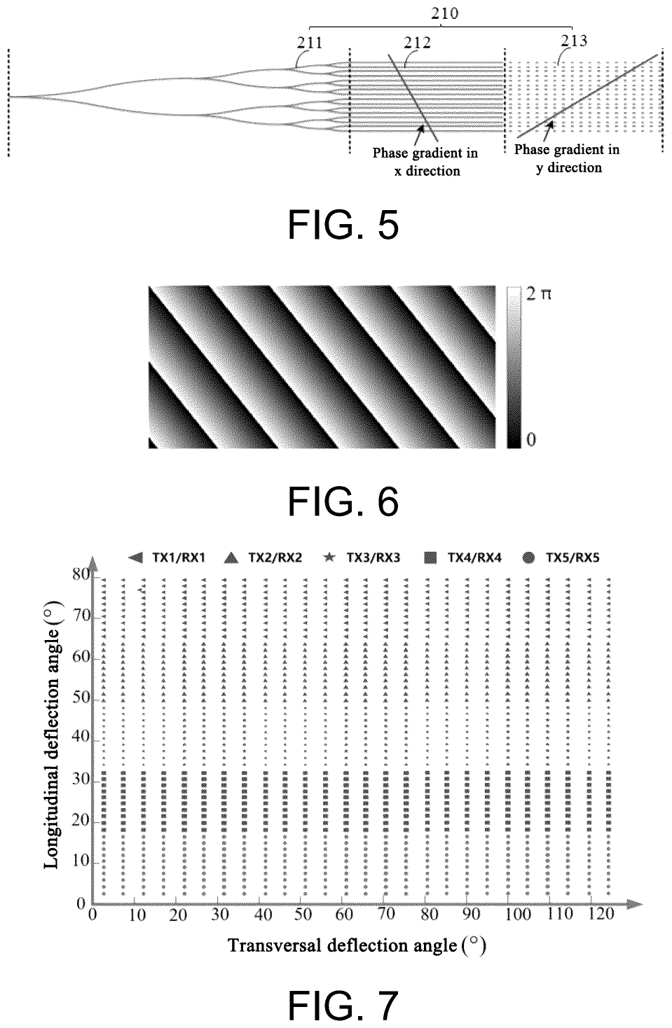

The operation principle of a lidar adopting the phased array lidar chip provided by an embodiment of the present disclosure is shown in FIG. 1 and FIG. 5.

Laser 100 provides the laser beam, the laser beam used as the input light beam is coupled to the chip through the input coupler and then is divided into the detection light and the reference light via the first beam splitter 700; the detection light enters the emitting beam splitter 211 and then is guided into multiple waveguide channels, where the number of the waveguide channels includes but not limited to any value within 128-8192; then the detection light is divided into multiple sub-beams, each sub-beam enters one phase shifter in the first phase shifter group 212, and is applied by a different phase respectively to form a phase gradient in the first dimension (i.e. a phase gradient in x direction), that is the emission angle range is changed transversely. The phase shifting principle of the phase shifter includes but is not limited to the Pockels effect, plasma dispersion effect, thermal-optical effect, and acousto-optical effect.

After that, respective sub-beams enter into an area where the first grating antenna 213 is located, while a phase gradient in a second dimension (i.e. a phase gradient in y direction) is formed under the diffraction effect of the first grating antenna 213, that is, the emission angle range is changed longitudinally. After that, the sub-beams are emitted out to the detection space through the first grating antenna. The phase distribution of the detection light after being emitted out via the emitting unit 210 is shown in FIG. 6, the output point cloud is shown in FIG. 7.

After entering into the detection space, detection light reflected by obstacles forms echo signal. In corresponding emitting unit and the receiving unit, the receiving angle range in the longitudinal direction can be aligned with the emission angle range by modulation of the second phase shifter, so the echo signal can firstly enter into the second grating antenna 224 and then enter into respective phase shifters in the second phase shifter group 223. After that, the echo signal enters into the receiving beam combiner 222, and is combined via the receiving beam combiner 222, then the combined echo signal enters into the first combiner 800, while the reference light and the echo signal form a beat-frequency signal at the first beam combiner 800. After that, the beat-frequency signal enters into the detection module 221, the detection module 221 processes the beat-frequency signal and outputs a corresponding electrical signal outward, the electrical signal is then processed via an external data processing apparatus to obtain relevant measurement data of the obstacles, such as distance, speed and obstacle volume, etc.

During the above process, after passing through the emitting unit 210, a phase plane array formed by the phase gradients of the two dimensions is shown in FIG. 6. By adjusting the phase gradient of the phase shifter and the wavelength of the laser beam, spot scanning in both dimensions can be achieved.

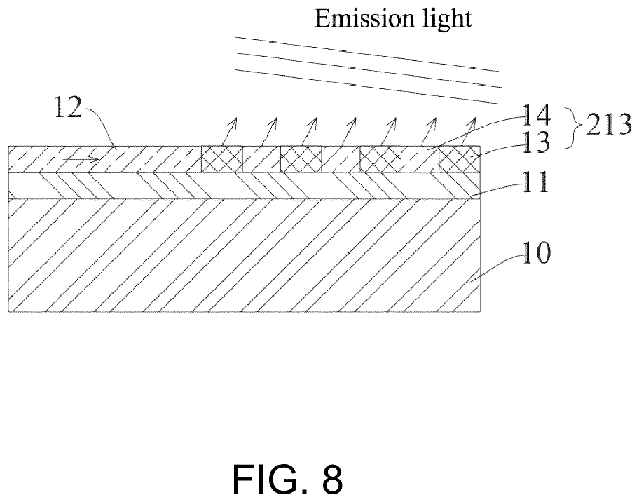

In addition to the laser 100 and the transceiver unit 200, the phased array lidar chip generally also includes a substrate 10, where the transceiver unit 200 is provided on the substrate 10 and the laser 100 is provided outside the substrate 10. In this case, the installation manner of the first grating antenna 213 can be shown in FIG. 8, an optical isolation layer 11 is provided on the surface of the substrate 10, a waveguide layer 12 is provided on the surface of the optical isolation layer 11, and a first grating antenna 213 is provided on the waveguide layer 12.

The diffraction principle of the detection light when passing through the first grating antenna 213 is as follows.

Typically, the first grating antenna 213 has a periodic grating structure and a periodic refractive index distribution through a patterned waveguide. When a light beam passes through a grating structure, a diffraction phenomenon occurs, and some of the light beam is diffracted. The wavelength of the incident light and the periodic refractive index distribution determine the phase difference between adjacent diffraction units, that is, the emission angle of the second dimension. The emission angle of the diffraction grating can be described by a diffraction equation, and a first-order diffraction equation can be expressed as:

$${neff}_{j} - {n}_{1} \cdot sin ( θ ) = λ / Λ ,$$

where, Λ is the period of the grating, n1 is the refractive index of the clad layer, 2 is the wavelength of the incident light, θ is the angle between the diffracted light and the normal of the emitting plane, neffⱼ is an equivalent refractive index of the waveguide in the grating area. As shown in FIG. 8, the first grating antenna 213 has a first area 13 and a second area 14 that are distributed alternatively, where the effective refractive index of the first area 13 is neff₁, the effective refractive index of the second area 14 is neff₂, an equivalent refractive index neffⱼ of the first grating antenna 213 can be expressed as:

$${neff}_{j} = {neff}_{1} \cdot FF + {neff}_{2} \cdot ( 1 - FF ) .$$

FF is the duty cycle of the grating. From the formula, it can be seen that when the wavelength of the incident light/or the equivalent refractive index neffⱼ of the grating varies, the emission angle will vary, thus beam scanning is achieved.

The integrated optical technologies which is the basis of the phased array lidar in this embodiment can be applied to, but not limited to, silicon-on-insulator, silicon nitride on insulator and thin film lithium niobate on insulator.

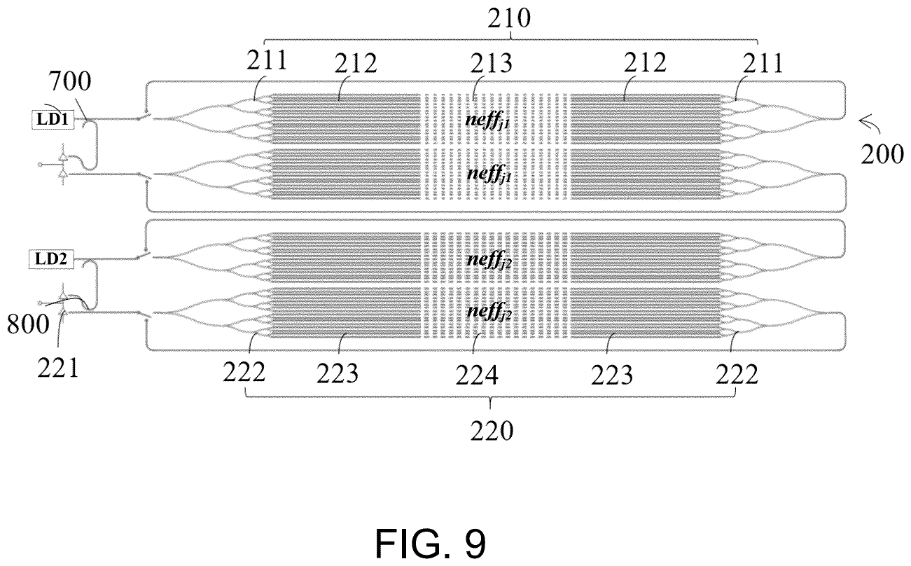

According to the phased array lidar chip provided by the embodiment of the present disclosure, the structures of the emitting unit 210 and the receiving unit 220 are simple, and at least one emitting unit 210 and multiple receiving units 220 can constitute multiple transceiver phased array arrays. By adjusting the antenna structures of different arrays, different emission angles under the same wavelength can be achieved, point clouds of the transceiver units are spliced finally, thereby achieving large field of view angle scanning, and meeting the requirements of scenarios, such as autonomous driving, for large field of view angle in two dimensions. As shown in FIG. 9, in some embodiments, in at least one transceiver unit, the emitting unit 210 includes two emitting beam splitters 211 and two first phase shifter groups 212, two emitting beam splitters 211 and two first phase shifter groups 212 in the same emitting unit 210 are respectively provided at two sides of a same first grating antenna 213, two emitting beam splitters 211 in the same emitting unit 210 are connected to the input coupler through a first selective switch 214. The receiving unit 220 includes two receiving beam combiners 222 and two second phase shifter groups 223, two receiving beam combiners 222 and two second phase shifter groups 223 in the same receiving unit 220 are respectively provided at two sides of the same second grating antenna 224, two receiving beam combiners 222 in the same receiving unit 220 are connected to a same detection module 221 through a second selective switch 226.

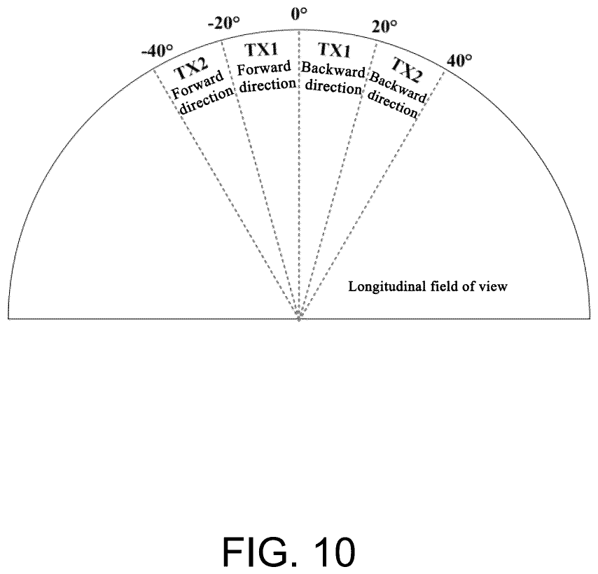

As shown in FIG. 10, by adopting the structure provided in this embodiment, a longitudinal scanning range of 80° can be achieved by utilizing only two groups of transceiver units. This is achieved by placing phase shifters and beam splitting structures on both sides of the antenna structure, and selecting whether the light is incident from the left or right side of the second grating antenna 224 through the first optical switch 400. Due to that the direction of light propagation is totally opposite, its emission angle will also be symmetrical along the normal of the chip in the far field. Therefore, the field of view angle range of a single transceiver unit is doubled up, and the required large field of view angle range is achieved by further splicing two groups of transceiver units.

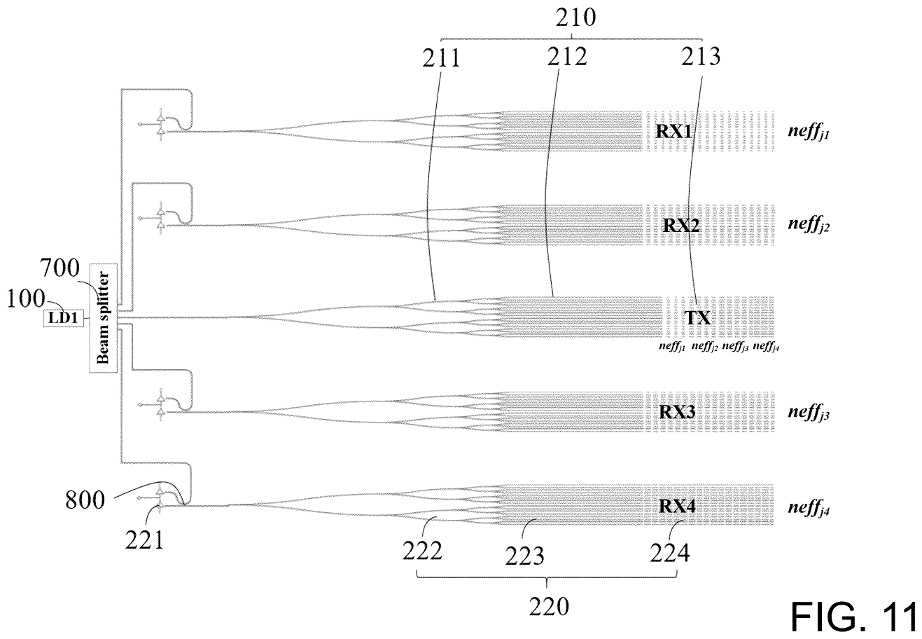

As shown in FIG. 11, in some embodiments, the emitting unit 210 is provided with one, the first grating antenna 213 is provided with multiple areas, each area corresponds to a different scanning range.

In this embodiment, the first grating antenna 213 has multiple grating areas, different areas have different effective refractive indexes and correspond one-to-one with the second grating antennas 224 in respective receiving units 220. In this way, the quantity of the emitting units 210 in the chip can be less, which is conducive to the miniaturization design of the chip or the placement of more receiving units 220 in a limited chip area.

As shown in FIG. 11, in some embodiments, the laser 100 is provided with one, the emitting unit 210 is provided with one.

By adopting the structure provided by the embodiment, the laser can adopt a single tunable laser 100 and utilize the first beam splitter 700 to divide the light into one beam of detection grating and multiple beams of reference light for receiving beat-frequency. The first grating antenna 213 has multiple grating areas, different areas have different effective refractive indexes and correspond one-to-one with the second grating antennas 224 in respective receiving units 220. This solution reduces the quantity of emission unit 210 to one on the basis of a single laser, which can significantly reduce the chip area or place more receiving units 220 in a limited chip area.

In some embodiments, both the first grating antenna 213 and the second grating antenna 224 are any one of a sidewall-etched grating, a shallow-etched grating, a full-etched grating and a loading-type grating.

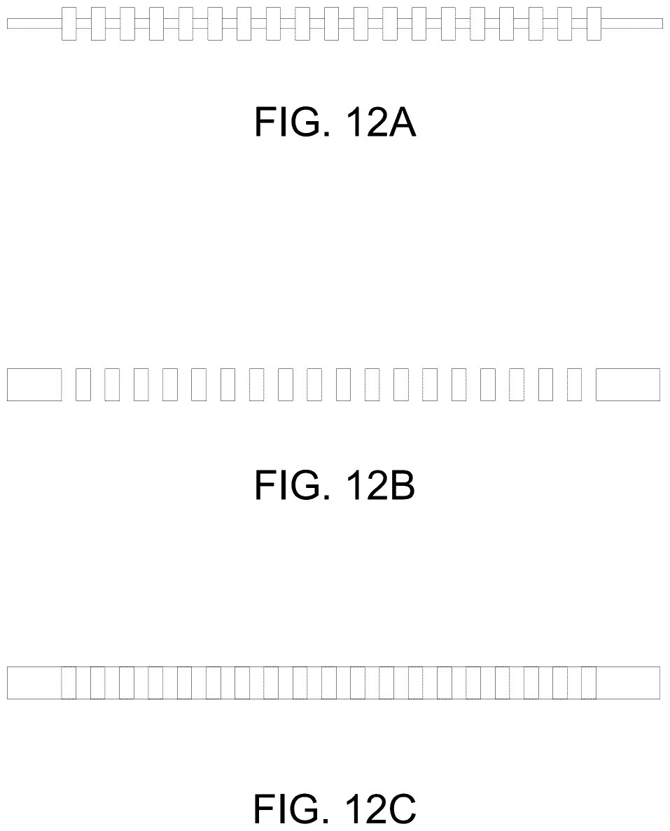

As shown in FIGS. 12A, 12B and 12C, these are schematic structure diagrams of a first grating antenna 213, which provides schematic diagrams of three possible antenna structures in the figure. The first one, as shown in FIG. 12A, is the sidewall-etched grating which has a periodic arrangement of waveguide structures with different widths. The second one, as shown in FIG. 12B, is the shallow-etched grating, the grating structure has same widths but different thicknesses, which results in differences in refractive indexes. The third one, as shown in FIG. 12C, is the full-etched grating where a partial area only having cladding material within each cycle. In some other embodiments, the first grating antenna may be the loading-type grating which includes periodic structures formed by depositing optical materials and patterning them, where the types of optical materials include but are not limited to amorphous silicon, polysilicon, silicon nitride, and silicon oxynitride.

The first grating antenna 213 and the second grating antenna 224 adopt the structure provided by this embodiment, which is easy to design and prepare, and the technology is mature.

As shown in FIG. 1, another embodiment of the present disclosure further provides a lidar, including the laser 100 and the phased array lidar chip provided by respective embodiments. The laser 100 is configured to provide a laser beam.

The laser 100 can be provided with one or more, which can be determined specifically according to usage requirements.

By adopting the lidar provided by the embodiments of the present disclosure, the scanning range can be increased to a certain extent, and the requirements of autonomous driving for field of view angle can be met.

The above descriptions are only illustrative embodiments of the present disclosure and specifically describes the technical principles of the present disclosure. These descriptions are only intended to explain the principles of the present disclosure and cannot be interpreted in any way as limiting the protection scope of the present disclosure. Based on the explanation here, any modifications, equivalent substitutions, and improvements made within the spirit and principles of the present disclosure, as well as other specific embodiments of the present disclosure that can be associated without creative efforts by those skilled in the art, shall be included in the protection scope of the present disclosure.

What is claimed is:

1. A phased array lidar chip, comprising:
an input coupler, configured to couple a laser beam to the phased array lidar chip, and provide the laser beam to an emitting module;
the emitting module, comprising at least one emitting unit, wherein the emitting unit is configured to emit the laser beam to a detection space; and
a receiving module, comprising multiple receiving units, wherein the receiving units are configured to receive an echo signal within the detection space, and each receiving unit corresponds to a different scanning range.

2. The phased array lidar chip according to claim 1, wherein the phased array lidar chip further comprises:
a first beam splitter, configured to receive the laser beam provided by the input coupler, dividing the laser beam into a detection light and a reference light, and providing the detection light to the emitting module, emitting the detection light to the detection space by the emitting module; and
a first beam combiner, configured to receive the reference light and the echo signal, wherein the reference light and the echo signal are combined in the first beam combiner to generate a beat-frequency signal.

3. The phased array lidar chip according to claim 2, wherein the phased array lidar chip further comprises a detection module, the detection module is configured to receive the beat-frequency signal and convert the beat-frequency signal into a difference-frequency electrical signal.

4. The phased array lidar chip according to claim 2, wherein the emitting unit is provided with multiple, the receiving units and the emitting units are provided in one-to-one correspondence, and a receiving unit and an emitting unit that are provided in correspondence have a same scanning range and form a transceiver unit.

5. The phased array lidar chip according to claim 4, wherein the phased array lidar chip further comprises a second beam splitter, the second beam splitter is located between the first beam splitter and the emitting module, the second beam splitter is configured to divide the detection light into multiple beams and respectively provide the multiple beams to the multiple emitting units.

6. The phased array lidar chip according to claim 4, wherein the phased array lidar chip further comprises multiple first optical switches, the first optical switches are located between the input coupler and the first beam splitters, the multiple first optical switches and the multiple emitting units are provided correspondingly, and the first optical switches are configured to control conduction of corresponding transceiver units.

7. The phased array lidar chip according to claim 4, wherein the phased array lidar chip further comprises multiple second optical switches and multiple third optical switches; the second optical switches are located between the input coupler and the emitting units, the multiple second optical switches and the multiple emitting units are provided correspondingly, the second optical switches are configured to control conduction of corresponding emitting units; the multiple third optical switches and the multiple receiving units are provided correspondingly, the third optical switches are located between the first beam combiner and the receiving units, the third optical switches are configured to control conduction of corresponding receiving units.

8. The phased array lidar chip according to claim 2, wherein the emitting unit comprises an emitting beam splitter, a first phase shifter group and a first grating antenna that are sequentially connected; the laser beam is capable of sequentially passing through the emitting beam splitter, the first phase shifter group and the first grating antenna to emit to the detection space;
the receiving unit comprises a receiving beam combiner, a second phase shifter group and a second grating antenna that are sequentially connected, the echo signal is capable of sequentially passing through the second grating antenna, the second phase shifter group and the receiving beam combiner to be received.

9. The phased array lidar chip according to claim 4, wherein in at least one transceiver unit, the emitting unit comprises two emitting beam splitters and two first phase shifter groups, two emitting beam splitters and two first phase shifter groups in a same emitting unit are respectively provided at two sides of a same first grating antenna, two emitting beam splitters in a same emitting unit are connected to the input coupler through a first selective switch;
the receiving unit comprises two receiving beam combiners and two second phase shifter groups, two receiving beam combiners and two second phase shifter groups in a same receiving unit are respectively provided at two sides of a same second grating antenna, two receiving beam combiners in a same receiving unit are connected to the first beam combiner through a second selective switch.

10. The phased array lidar chip according to claim 8, wherein the emitting unit is provided with one, the first grating antenna is provided with multiple areas, and each area corresponds to a different scanning range.

11. The phased array lidar chip according to claim 8, wherein both the first grating antenna and the second grating antenna are any one of a sidewall-etched grating, a shallow-etched grating, a full-etched grating and a loading-type grating.

12. A lidar, comprising a laser and a phased array lidar chip, the laser is configured to provide a laser beam;
wherein the phased array lidar chip comprises:
an input coupler, configured to couple the laser beam to the phased array lidar chip, and provide the laser beam to an emitting module;
the emitting module, comprising at least one emitting unit, wherein the emitting unit is configured to emit the laser beam to a detection space; and
a receiving module, comprising multiple receiving units, wherein the receiving units are configured to receive an echo signal within the detection space, and each receiving unit corresponds to a different scanning range.

13. The lidar according to claim 12, wherein the phased array lidar chip further comprises:
a first beam splitter, configured to receive the laser beam provided by the input coupler, dividing the laser beam into a detection light and a reference light, and providing the detection light to the emitting module, emitting the detection light to the detection space by the emitting module; and
a first beam combiner, configured to receive the reference light and the echo signal, wherein the reference light and the echo signal are combined in the first beam combiner to generate a beat-frequency signal.

14. The lidar according to claim 13, wherein the phased array lidar chip further comprises a detection module, the detection module is configured to receive the beat-frequency signal and convert the beat-frequency signal into a difference-frequency electrical signal.

15. The lidar according to claim 13, wherein the emitting unit is provided with multiple, the receiving units and the emitting units are provided in one-to-one correspondence, and a receiving unit and an emitting unit that are provided in correspondence have a same scanning range and form a transceiver unit.

16. The lidar according to claim 15, wherein the phased array lidar chip further comprises a second beam splitter, the second beam splitter is located between the first beam splitter and the emitting module, the second beam splitter is configured to divide the detection light into multiple beams and respectively provide the multiple beams to the multiple emitting units.

17. The lidar according to claim 15, wherein the phased array lidar chip further comprises multiple first optical switches, the first optical switches are located between the input coupler and the first beam splitters, the multiple first optical switches and the multiple emitting units are provided correspondingly, and the first optical switches are configured to control conduction of corresponding transceiver units.

18. The lidar according to claim 15, wherein the phased array lidar chip further comprises multiple second optical switches and multiple third optical switches; the second optical switches are located between the input coupler and the emitting units, the multiple second optical switches and the multiple emitting units are provided correspondingly, the second optical switches are configured to control conduction of corresponding emitting units; the multiple third optical switches and the multiple receiving units are provided correspondingly, the third optical switches are located between the first beam combiner and the receiving units, the third optical switches are configured to control conduction of corresponding receiving units.

19. The lidar according to claim 13, wherein the emitting unit comprises an emitting beam splitter, a first phase shifter group and a first grating antenna that are sequentially connected; the laser beam is capable of sequentially passing through the emitting beam splitter, the first phase shifter group and the first grating antenna to emit to the detection space;
the receiving unit comprises a receiving beam combiner, a second phase shifter group and a second grating antenna that are sequentially connected, the echo signal is capable of sequentially passing through the second grating antenna, the second phase shifter group and the receiving beam combiner to be received.

20. The lidar according to claim 15, wherein in at least one transceiver unit, the emitting unit comprises two emitting beam splitters and two first phase shifter groups, two emitting beam splitters and two first phase shifter groups in a same emitting unit are respectively provided at two sides of a same first grating antenna, two emitting beam splitters in a same emitting unit are connected to the input coupler through a first selective switch;
the receiving unit comprises two receiving beam combiners and two second phase shifter groups, two receiving beam combiners and two second phase shifter groups in a same receiving unit are respectively provided at two sides of a same second grating antenna, two receiving beam combiners in a same receiving unit are connected to the first beam combiner through a second selective switch.
